(19) United States
(12) Patent Application Publication
(10) Pub. No.: US 2010/0132273 A1
(43) Pub. Date: Jun. 3, 2010

(54) METHOD FOR PRODUCING AN INSULATING MATERIAL ELEMENT AND INSULATING MATERIAL ELEMENT

(75) Inventor: Herbert Pieper, Duelmen (DE)

Correspondence Address: HARNESS, DICKEY & PIERCE, P.L.C., P.O. BOX 828, BLOOMFIELD HILLS, MI, 48303, US

(73) Assignee: DEUTSCHE ROCKWOOL MINERALWOLL GMBH & CO. OHG, Gladbeck (DE)

(21) Appl. No.: 12/599,770

(22) PCT Filed: May 8, 2008
(86) PCT No.: PCT/EP2008/003684

§ 371 Date: Jan. 19, 2010

(30) Foreign Application Priority Data
May 18, 2007 (DE) 10 2007 023 368.1

(51) Int. Cl. E04B 1/74; B32B 38/00; E04C 2/24

(52) U.S. Cl. 52/144; 156/212; 52/782.1; 52/748.11

(57) ABSTRACT

The present invention relates to a method for producing an insulating material element and an insulating material element. In order to provide a method for producing an insulating material element by which a very resistant insulating material element can be made that is able to insulate a flat building surface very effectively against heat and/or sound, the invention proposes that the insulating material element (2) be bent such that a surface segment of the first large surface forms at least one surface segment of the side surfaces running parallel to the recess in said area, and is substantially flush to the second large surface. In order to provide an insulating material element (2) for insulating two building surfaces aligned at an angle of β≠0° to each other against heat and/or sound that can be adapted to the angle β such that an effective heat and/or sound insulation of the building surfaces can be attained, the invention proposes that the recess extend to the lamination (3) without weakening the lamination (3), and that the recess comprise two surfaces (6, 7) running at an angle α to each other, the angle α corresponding to the difference between 180° and the angle β between the building surfaces.

The present invention relates to a process for producing an insulating element, particularly an insulating element for thermal and/or sound insulation of a flat surface of a building, preferably the facade of a building, in which process a substantially block-shaped insulating element comprising two large surfaces substantially extending parallel to each other and spaced from each other and four lateral surfaces substantially extending at right angles to the large surfaces is bent along at least one recess formed in one of the large surfaces.

The invention further relates to an insulating element, particularly an insulation panel for thermal and/or sound insulation of two surfaces of a building, preferably the facade of a building, which are oriented to each other under an angle β≠0°, which insulation element comprises an insulating layer having two large surfaces substantially extending parallel to each other and with a distance to each other, and four lateral surfaces substantially extending at right angles to the large surfaces, wherein a first large surface includes a lamination and wherein at least one recess is formed in the second large surface opposing the first large surface, said recess extending over the entire length or width of the second large surface.

Such process for producing an insulating element are known in prior art. Austrian patent specification AT 319 453 B for instance describes a process for the production of an insulating element for thermal insulation between an inner pipe and an outer sheath of a chimney or chute shaft. To enable bending of the insulating element into a round, oval or also almost rectangular shape, the insulating element includes transverse slots subdividing the insulating element into a series of longitudinal elements capable of being pivoted in the fashion of a joint about a part of the circumferential side where they are connected to each other or through a flexible flat film.

From utility model DE 296 07 387 U1 a process is known for producing an insulating element for thermal insulation of pipelines having a polygonal cross section. To this end, the substantially block-shaped insulating element comprises several substantially parallel extending recesses enabling a corresponding adaption of the insulating element to an outer contour of a pipeline in such a manner that a tightly fitting thermal insulation layer is obtained.

European patent specification EP 0 698 195 B1 describes an inner lining of a pipe for an air conditioning system, wherein a panel having a body made of mineral wool and including a lining on both sides of the body is provided with incisions allowing the panel to be bent about the bottom of the incisions, so that by bending the panel an insulating inner lining of a pipe can be obtained for example for a pipe with a rectangular cross section.

Further, the published patent application DE 25 08 733 A1 discloses a thermal and sound insulation sheath for ventilation and air conditioning systems, wherein a panel-like insulating element is provided on one side thereof with recesses allowing the insulating element to be adapted to different geometries of ventilation and air conditioning systems, by bending the insulating element about the longitudinal elements formed by the recesses, in the connecting area thereof.

Further, German utility model DE 82 32 324 U1 discloses an insulating mat for bodies having a curved surface, wherein the insulating mat is provided in the transverse direction with recesses allowing the insulating mat to be adapted conforming to the shape of a pipe.

Further, the American patent specification U.S. Pat. No. 3,336,951 A describes a process for producing an insulating element for covering pipes and other curved surfaces of a different size. To this end, a flat panel is provided with several incisions allowing wedge-shaped elements to be removed from one side of the panel, so that the panel can be bent via remaining strips connected to the panel, for adapting the panel for example to a pipe.

In view of this prior art, the invention is based on the object of further improving a process for producing an insulating element in such a manner that a very sturdy insulating element can be obtained, with which a flat surface of a building can be very effectively heat and sound-insulated.

On part of the device, the invention is based on the object of providing an insulating element for thermal and/or sound insulation of two surfaces of a building oriented to each other under an angle β≠0°, which insulating element can be adapted to the respective angle β in such a manner that an effective thermal and/or sound insulation of the surfaces of the building can be made.

On part of the process, the solution of the object provides that the insulating element is bent along at least one recess formed in one large surface, so that a surface section of the first large surface constitutes at least one surface section of the lateral surface extending in this region parallel to the recess and terminates substantially flush with the second large surface.

In the thermal and/or sound insulation of building surfaces the insulating elements mostly form a butt joint at the corners between the building surfaces. If such a corner is an inside corner, the optical appearance of a building corner provided with such insulating elements and the robustness of this thermal and/or sound insulation are not negatively influenced. But if the corner is an outside corner, one lateral surface of an insulating element is exposed at the corner of the building, so that the insulating element might be easily damaged in this region, because the lateral surfaces are not as resistant to loads as for example the large surfaces of the insulating element. Through the bending along a recess in one large surface, the more resistant structure of the large surface is also conveyed to a corresponding lateral surface of the insulating element, so that an insulating element produced by the process of the invention is very sturdy and can be very easily adapted to the respective conditions on site.

An advantageous construction of the invention provides that the recess is V-shaped with two mutually converging surfaces, wherein an angle of 90° is preferably included between the surfaces. This construction enables the insulating element being bent about the remaining part of the insulating element in the region of the V-shaped recess, so as to meet the respective requirements on site. The angle which is included by the two mutually converging surfaces can be varied depending on the respective requirements, but in view of the fact that angles of 90° rather frequently occur in building facades, the included angle is preferably 90°, so that a building which is provided with these insulating elements does not have any exposed lateral surfaces of the insulating elements on corresponding outer edges, which could otherwise constitute a weak point in the insulation provided on the building.

A further advantageous construction of the invention provides that the first large surface is provided with a preferably full-area lamination, especially from a non-woven material, woven material and/or a film. This lamination serves to increase the stability of the insulating element and on the other hand to improve the optical appearance of a corresponding insulating element. This is important especially in a case where for example natural stone facades having joints of several mm joint width are provided. Depending on the desire and requirements, a non-woven material, woven material and/or a film can be selected as a lamination, especially a glass non-woven or woven material. If an insulating element is provided with such a lamination, it is particularly important that the optical appearance of a building facade provided with such insulating elements is not negatively affected by exposed lateral surfaces of insulating elements. In this respect, an advantage of the process of the invention and of the insulating element fabricated by this process becomes even more apparent, because on the surface opposite the surface provided with the lamination a recess can be formed parallel to one lateral surface, so that the insulating element can be bent about this recess in such a manner that for example in an outside corner of 90° the lamination is seamlessly continued from the large surface to the lateral surface of the insulating element, so that the optical appearance of the building facade is not negatively affected.

A further advantageous embodiment of the invention provides that the recess is formed so as to extend up to the lamination. Thus the insulating element is given maximum flexibility in the region of the recess, so that a very precise and uniformly tightly fitting thermal and/or sound insulation of a building facade can be created, because there is not tension or compression on the insulating material.

A further advantageous embodiment of the invention provides that the recess is made in the form of two converging incisions oriented to each other under an angle. The two incisions are not designed to cross each other, and a part arranged between the two incisions can be removed from the insulating material. These incisions in an insulating element are made for example in the factory. Thus a part arranged between the converging incisions, which are oriented to each other under an angle, can be removed from the insulating element on site, depending on the requirements. Accordingly, an insulating element is provided in the factory which is adaptable in a highly versatile fashion and which offers maximum flexibility concerning its adaptation to particular facade designs of buildings.

According to a further advantageous embodiment of the invention two recesses are formed extending parallel to the edges between the large surfaces and to the parallel extending lateral surfaces. The recesses are also oriented so as to extend parallel to each other and are equally spaced from the respective edge. Thus one or more rims can be bent if necessary, in order to provide a corresponding number of lateral surfaces with the lamination.

A further advantageous embodiment of the invention provides that within the recess an adhesive is arranged, particularly an adhesive that can be activated. Thus the advantage is achieved that the mutually converging surfaces of the recesses can be placed one against the other and connected to each other by an adhesive after bending a part of the insulating element, so that the insulating element fabricated by the process keeps the desired shape, whereby an easy-to-handle and also very effective insulating element is provided. The adhesive can be applied for example to one of the two converging surfaces of a recess over the surface, in a dot and/or bead-like fashion. It is also possible to provide both converging surfaces of the recess with adhesive, or one of the surfaces is provided with an adhesive covered with a protective sheet that can be removed on site, thus exposing the adhesive for sticking the convergent surfaces together. Preferably, the adhesive is one that can be activated, for example by water or heat.

On part of the device, the solution of the object provides that the recess extends up to the lamination, without weakening the lamination, and that the recess includes two surfaces which converge toward each other under an angle α, the angle α corresponding to the difference of 180° and the angle β between the building surfaces. As already described above, the lamination increases the stability of the insulating element, and due to the fact that the recesses extend up to the lamination, a very flexible insulating element is provided. Further, an insulating element according to the invention is provided with recesses having two surfaces converging toward each other under an angle α, the angle α being adaptable to the respective conditions of a building facade on site, so that finally a very effective insulating element is created which is accurate to shape and provides for a uniformly tight fit.

According to a preferred embodiment of the invention, the layer is made up from mineral fibers bound with a binding agent, especially from rock and/or glass wool fibers. By the layer being constructed in this way, an insulating element is provided which is capable of being adapted in its strength properties and in its flexibility to the most different requirements, by selecting the type and amount of the binding agent and the arrangement of the mineral fibers. At the same time the insulating element provides for an excellent thermal and/or sound insulation of a building facade.

According to a further advantageous proposal of the invention, the recess is formed with a V-shaped cross section. This enables two substantially plane surfaces being formed which can be easily pivoted about their connecting area, in order to contact each other in a form-fit fashion, without tension or compression loads on the material which might affect the dimensional stability of the insulating element and its insulating effect.

A further advantageous construction of the invention provides that at least one surface is provided with an adhesive, especially an adhesive which can be activated. This adhesive offers the advantages mentioned above in context with the process of the invention, the adhesive being selected corresponding to the requirements and being arranged on at least one surface of the recess.

A further advantageous construction of the invention provides that the recess is made in the form of two incisions oriented so as to converge toward each other under an angle α. The incisions do not cross each other, so that between the incisions an element of insulating material is formed which can be removed, if necessary. It is further proposed for the recess being made in the form of several incisions which are oriented so as to converge toward each other under different angles α. The incisions do not cross each other, so that between the incisions elements of insulating material are formed which can be removed, if necessary. This too offers the advantage that, as mentioned above, an insulating element according to the invention can be factory-provided with a corresponding number of incisions and associated recesses allowing a part of insulating material to be removed from the insulating element on site and according to the requirements, so that the insulating element can be bent as required.

A further advantageous construction of the invention provides that the recess is centrally arranged in the second large surface. It is further proposed that the second large surface is subdivided into two differently wide surface sections, preferably at a ratio of one third to two thirds of the width or length of the second large surface. On the one side these constructions allow the provision of an insulating element suitable for being arranged in compliance with the respective design on an outside corner of a building facade in such a manner that the outside corner can be covered with a respective insulating element having legs with a length that corresponds to the requirements. The insulating elements can thus be arranged in an offset fashion on the building facade, whereby the stability of such a thermal and/or sound insulating construction is increased. Cross joints shall be avoided in this case.

A further advantageous construction of the invention provides that the recess has a width corresponding to twice the thickness of the insulating layer. This form of the recess is so to speak an averaged measure for such a recess, so that an insulating element capable of being adapted to the various conditions on site can be provided with only one type of the recess. This standardization also provides for maximum flexibility of use of an insulating element according to the invention, and its manufacture is simplified to a large extent, thus keeping the production cost as low as possible.

A further advantageous construction of the invention provides that the recess has a depth which substantially corresponds to the thickness of the insulating material layer. Thus the advantage is achieved that the connecting area between two parts of the insulating element, which are separated from each other by a recess, are connected to each other by a part which is as small and hence as flexible as possible, so that the insulating element can be bent in the area of the recesses, without tension or compression loads occurring within a corresponding insulating element.

Further advantages and features of the present invention will become apparent from the following description with reference to the drawings in which it is shown by:

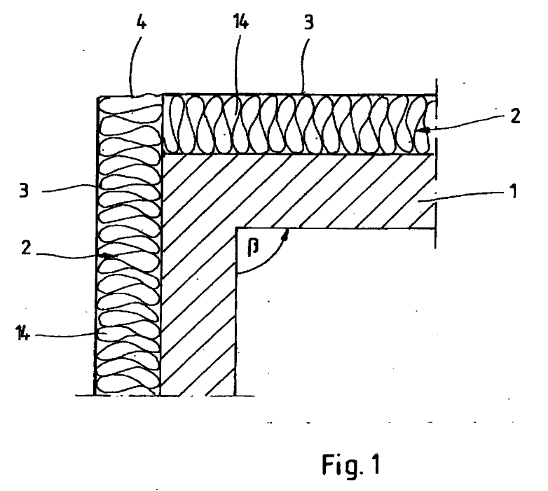

FIG. 1 an embodiment for a conventional thermal and/or sound insulation of an outside corner of a building surface using conventional insulating elements;

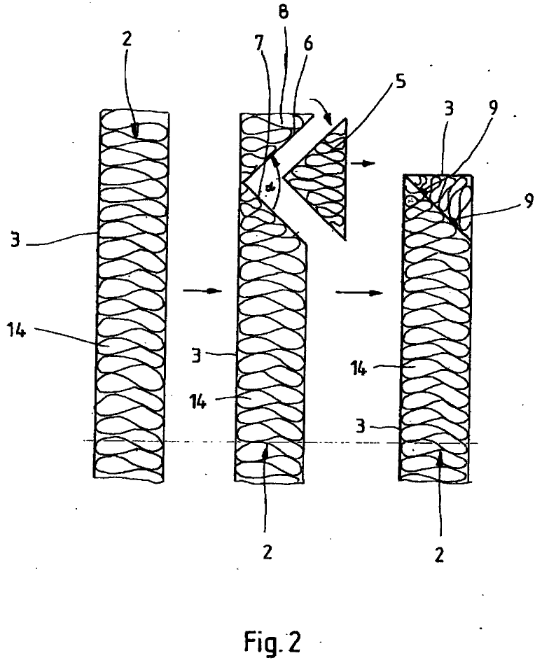

FIG. 2 an illustration of the process of the invention for the production of an insulating element;

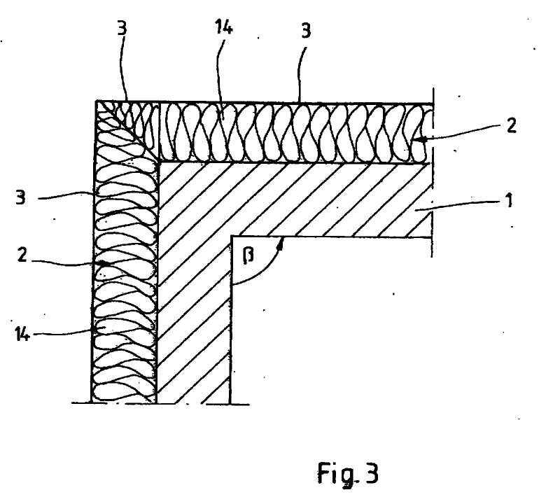

FIG. 3 an example of use of an insulating element produced using the process according to the invention;

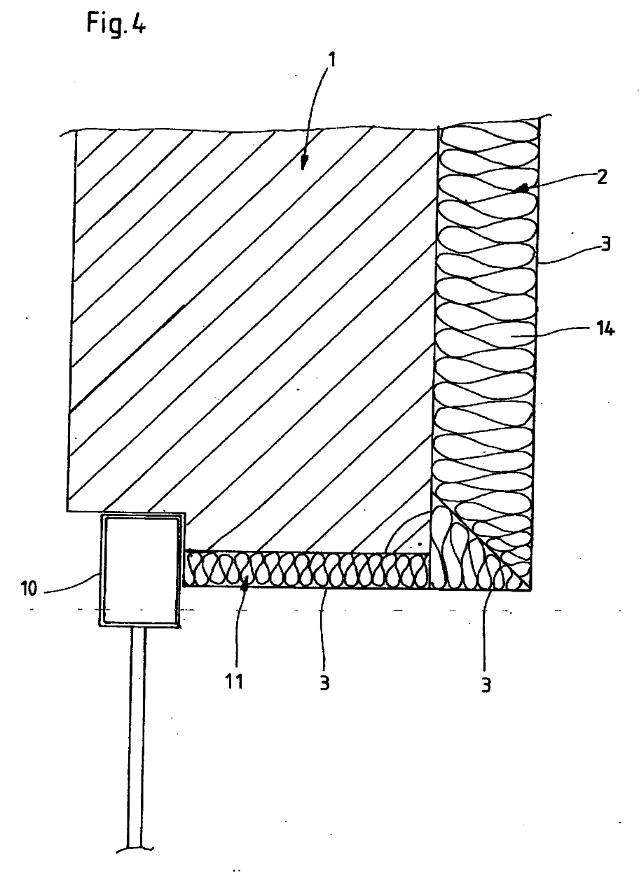

FIG. 4 a further example of use of a insulating element produced using the process according to the invention;

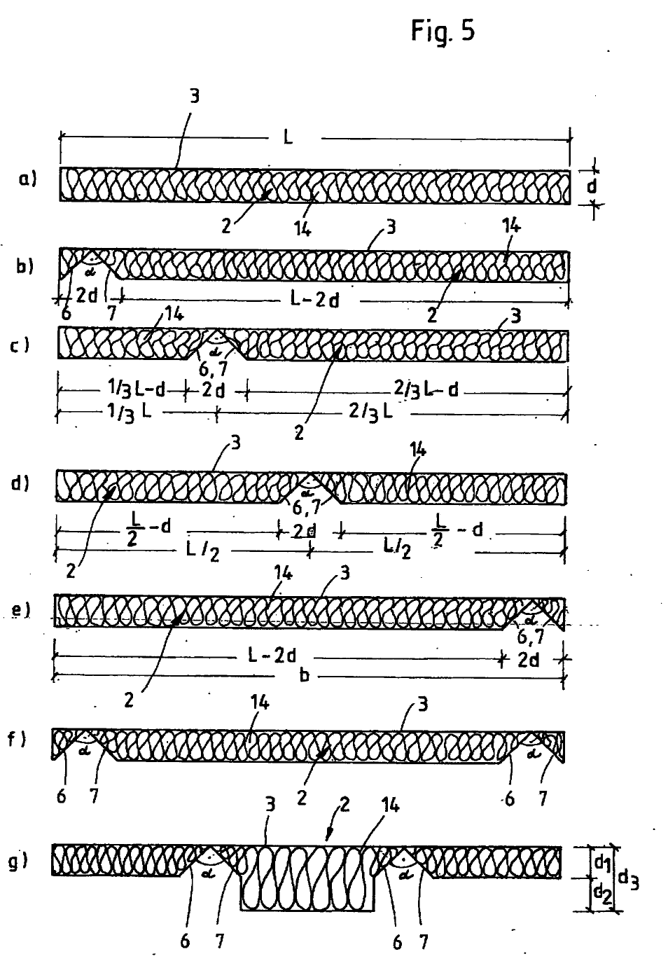

FIG. 5 embodiments of an insulating element according to the invention;

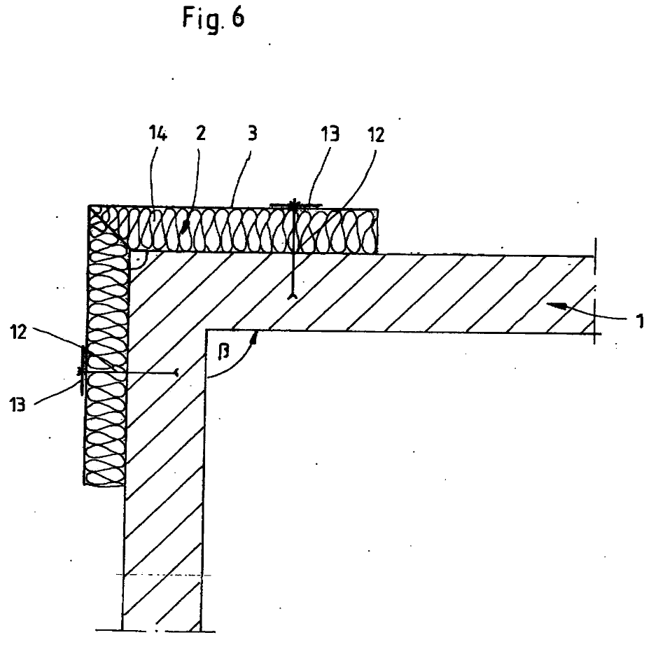

FIG. 6 an example of use of an embodiment of an insulating element according to the invention;

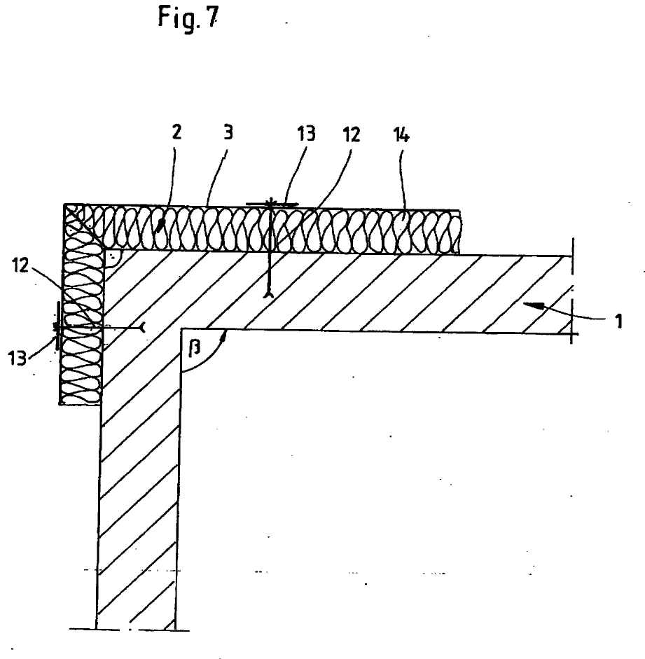

FIG. 7 a further example of use of an embodiment of an insulating element according to the invention;

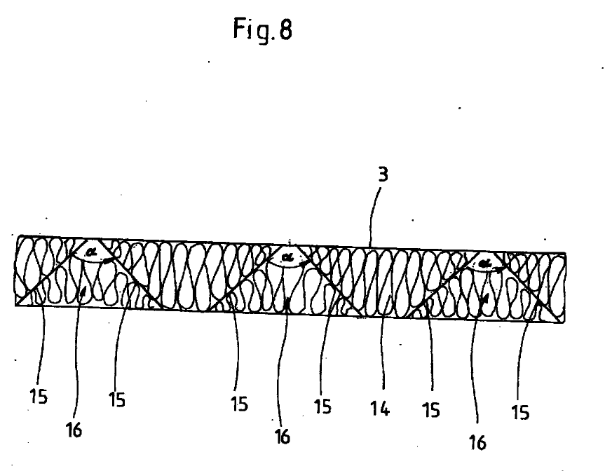

FIG. 8 an embodiment of insulating element according to the invention provided with incisions;

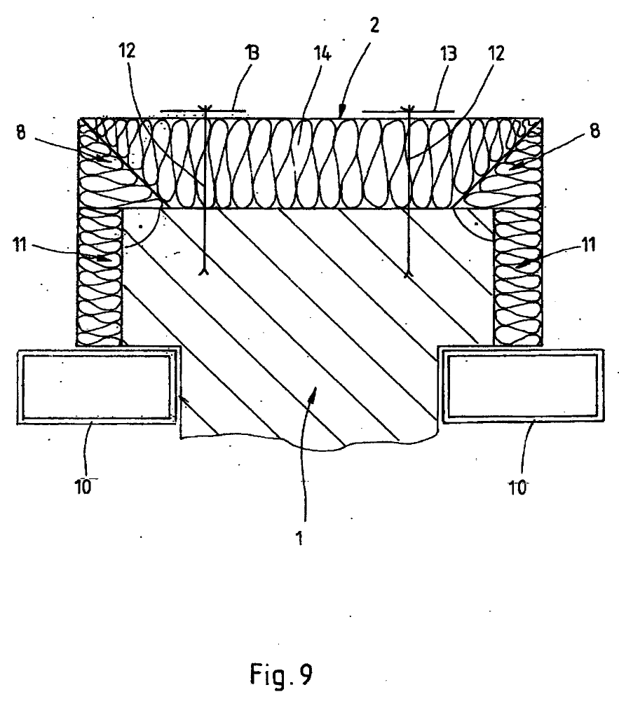

FIG. 9 a further example of use of an insulating element according to the invention;

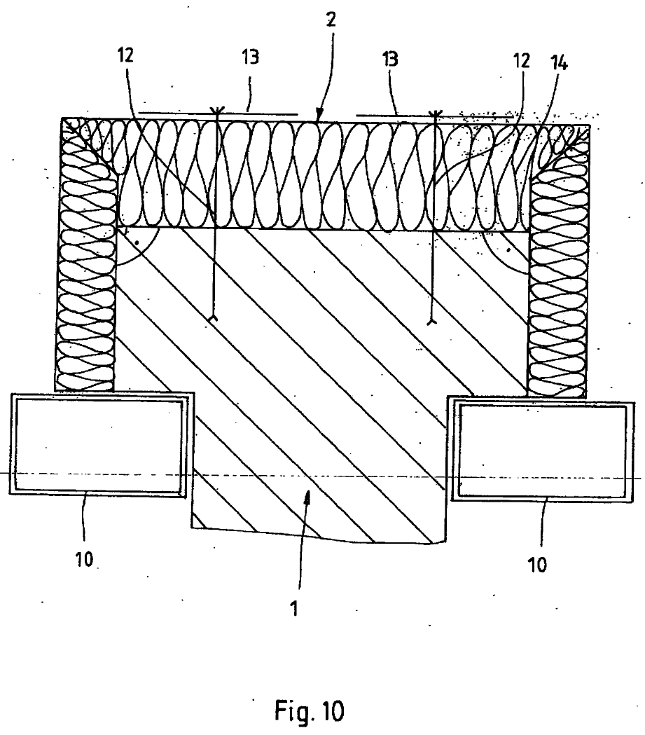

FIG. 10 a further example of use of an insulating element according to the invention; and

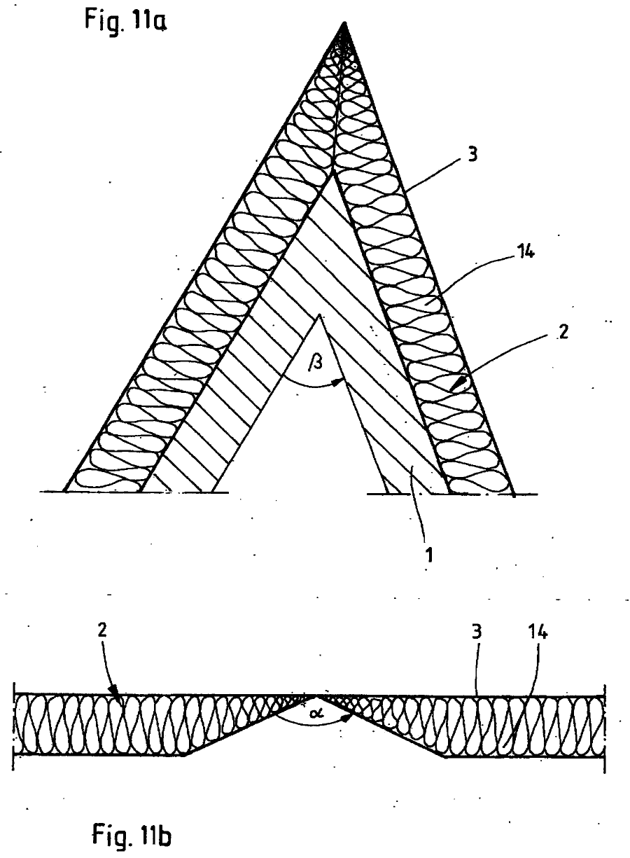

FIG. 11 a further example of use of an insulating element according to the invention.

FIG. 1 shows an outside corner of a building facade 1 with conventional insulating elements 2 butt-jointed thereon. The insulating elements 2 include an insulating layer 14, which is provided with a lamination 3 on its side facing away from the building facade 1. The lamination 3 increases the stability of the insulating elements 2 and provides for better optical appearance of the building facade 1 covered with these insulating elements 2. Because of the butt-jointed arrangement of the insulating elements 2 on the outside corner, one lateral surface 4 of an insulating element 2 not having a lamination 3 is exposed. This lateral surface 4 thus constitutes a weak point in the thermal and/or sound insulation of the building facade 1 and also affects the optical appearance of the building facade 1 covered with the insulating elements 2.

FIG. 2 illustrates an embodiment of the process of the invention for producing an insulating element 2, wherein a strip of insulating material 5 is removed from a panel-like insulating element 2, in order to form a recess, the depth of which extends up to the lamination 3. The recess includes two surfaces 6 and 7 converging toward each other and including a right angle. In a next step, the triangular end piece 8 of the insulating element 2 is bent in the clockwise direction, until the two surfaces 6 and 7 contact each other. Thus an insulating element 2 is provided in which the lateral surface 4 illustrated in FIG. 1 at the top is provided with a lamination 3, so that neither a weak point is created nor the optical appearance of the a building facade 1 provided with such insulating elements 2 is affected. Between the surfaces 6 and 7 bead-like stripes of adhesive 9 are arranged for sticking the two surfaces 6 and 7 together in their condition as shown, so that the insulation element 2 maintains the shape of the embodiment shown to the right.

FIG. 3 illustrates a first example of use of an insulating element 2 produced using the process according to the invention. FIG. 3 shows that compared to FIG. 1, the building facade 1 can be covered with insulating elements 2 without leaving non-laminated lateral surfaces 4 (FIG. 1) that would negatively influence the optical appearance and the stability of such a covering made from insulating elements.

FIG. 4 illustrates a further example of use of an insulating element 2 produced using the process according to the invention. This insulating element 2 is used for covering a door and/or window reveal. In this case, the insulating element 2 produced by the process of the invention is arranged on the facade 1, so that it protrudes over an outer edge of the facade a distance which is equal to the thickness of a reveal panel 11 arranged between a door and/or window frame 10. Here, too it becomes evident that an insulating element 2 produced by the process according to the invention allows a thermal and/or sound insulation of a building which is characterized by a high stability and also by a good optical appearance, without requiring additional working steps such as laminating the surfaces.

The FIGS. 5a to 5g illustrate various embodiments of an insulating element 2 according to the invention, wherein an insulating element 2 without a recess is shown in FIG. 5a and an insulating element 2 corresponding to an insulating element produced by the process according to the invention and including a recess in the rim area shown to the left is illustrated in FIG. 5b, while FIG. 5c shows an insulating element 2 which is subdivided by this recess substantially at ratio of 1:3 with respect to the length of the insulating element 2. FIG. 5d shows an insulating element 2 having a central recess, and FIG. 5e shows an insulating element 2 corresponding to FIG. 5b, in which the recess is provided on the rim of the insulating element 2 shown to the right. FIG. 5f shows an insulating element 2 provided with a recess on each of its rim areas, and FIG. 5g shows an insulating element 2 which includes sections of a different thickness. All the illustrated insulating elements 2 are provided with a lamination, in order to increase their stability and to improve their optical appearance. The recesses shown in the FIGS. 5b to 5g each have two surfaces 6 and 7 which converge toward each other and include a right angle. By being designed in this way, a corresponding recess is twice as wide as the thickness of a corresponding insulating element 2.

FIG. 6 shows an example of use of the insulating element 2 illustrated in FIG. 5d. The same includes a central recess, so that after bending in the region of the recess an insulating element 2 is formed having two equally long legs. Such an insulating element 2 can be fixed to the building facade 1, for example by means of insulating dowels 12 and/or by means of an adhesive, with a dowel plate 13 being preferably placed on the lamination 3 of the insulating element 2 and the insulating dowel 12 being passed through and fixed to the dowel plate, so that an insulating element 2 is held against the building facade 1 in such a manner that the holding power is distributed over a larger area of the insulating element, so that it is more difficult for the insulating element 2 to come off from the building facade 1 than in the case of its pointwise fixing to the building facade 1.

FIG. 7 shows an example of use of the insulating element 2 illustrated in FIG. 5c. This insulating element 2 is fixed to a building facade 1 in the same manner as the insulating element 2 shown in FIG. 6. In the insulating element 2 shown in FIG. 7, the legs are constructed with a different length, so that webs of insulating elements 2 arranged one above the other and extending horizontally may be offset among each other, which serves to increase the stability of such a thermal and/or sound insulation.

FIG. 8 shows an embodiment of an insulating element 2 according to the invention which is provided with six incisions 15 which are oriented under angle α. Two incisions 15 each extend toward each other in the direction of the lamination 3, without crossing each other. The section 16 of insulating material between these incisions 15 can thus be easily removed from the insulating element 2. The sections 15 can be removed by a cutting and/or milling operation. The incisions 15 are factory-arranged in the insulating element 2 and serve to provide a highly flexible insulating element 2 from which one or more sections 16 can be removed, depending on the requirements on site, in order to give the insulating element 2 the desired shape.

FIG. 9 is a further example of use of an insulating element 2 according to the invention. This example is concerned with the insulation of a window corner in which an insulating element 2 is arranged frontally on a part of a building facade 1 between two windows. This insulating element 2 is one as shown in FIG. 5f, in which the triangular end pieces 8 are pivoted about the rim-side recesses, with the surfaces 6 and 7 converging toward each other, so that the surfaces 6 and 7 can be stuck together using an adhesive tape for example (FIG. 2). Additionally, the insulating element 2 is fixed to the building facade 1 using insulating dowels 12, and dowel plates 13 are used for distributing the pressure over a large area and for securely supporting the insulating element 2 against the building facade 1. Between the window frame 10 and the insulating element 2, which laterally protrudes over the front of the illustrated building facade 1, a respective reveal panel 11 of lesser thickness is arranged, so that the building facade 1 is completely enclosed by an insulating layer.

FIG. 10 shows an alternative for the design of an insulating element 2 according to FIG. 9. This insulating element 2 corresponds to the insulating element shown in FIG. 5g. The insulating element 2 includes two recesses. Between these recesses the insulating element 2 has a section which is thicker than the section between the recesses and the rims of the insulating element 2. This design does not require the reveal panels 11 of lesser thickness shown in FIG. 9. The building facade 1 can be covered with a corresponding insulating element 2 according to FIG. 5g. The insulating element 2 is also fixed to the building facade 1 by means of an insulating dowel 12, and at least one dowel plate 13 is used also in this case, in order to achieve the above-described advantages.

FIG. 11 shows a last example of use of an insulating element 2 according to the invention. The insulating element 2 in FIG. 11 is arranged on a building facade 1, of which the building surfaces converge toward each other under an acute angle of approx 50°. FIG. 11b shows the insulating element 2 which has to be fabricated for this purpose and having the surfaces which converge toward each other under an angle α, the angle α in this embodiment being 180°−β=130°.

The embodiments which have been described above with reference to the drawings merely serve to explain the invention and are not in any way limiting to the invention.

### LIST OF REFERENCE NUMBERS

1 building facade
2 insulating element
3 lamination
4 lateral surface
5 insulating strip
6 surface
7 surface
8 triangular end piece
9 adhesive tape
10 door and/or window frame
11 reveal panel
12 insulating dowel
13 dowel plate
14 insulating layer
15 incision
16 section

1. The process for the production of an insulating element, particularly an insulating panel for thermal and/or sound insulation of a flat building surface, preferably a building facade, in which process a substantially block-shaped insulating element comprising a layer of mineral fibers bound with binding agents and comprising two large surfaces extending substantially parallel and with a distance to each other and four lateral surfaces substantially extending at right angles to the large surfaces, is bent along at least one recess formed in one of the large surfaces and in such a manner that a surface section of the first large surface constitutes at least one surface section of the lateral surface extending parallel to the recess in this region and terminates substantially flush with the second large surface.

2. A process according to claim 1, wherein the first large surface is preferably provided over its full area with a lamination, particularly from a non-woven material, a woven material and/or a film.

3. A process according to claim 2, wherein the recess is formed so as to extend up to the lamination.

4. A process according to claim 1, wherein the recess is V-shaped with two surfaces converging toward each other, with an angle α of preferably 90° being included between the surfaces.

5. A process according to claim 1, wherein the recess is made in the form of two incisions which are oriented and converge toward each other under an angle, wherein the two incisions are not formed in a fashion crossing each other and wherein a section of insulating material arranged between the incisions can be removed.

6. A process according to claim 1, wherein two recesses are formed extending parallel to the edges between the large surfaces and to the parallel extending lateral surfaces, said recesses also being oriented so as to extend parallel to each other, wherein the recesses are equally spaced from the respective edge.

7. A process according to claim 1, wherein in the recess an adhesive is arranged, particularly an adhesive which can be activated.

8. An insulating element, particularly an insulating panel for thermal and/or sound insulation of two building surfaces, preferably a building facade, oriented to each other under an angle β≠0°, said insulating element comprising a layer of insulating material which comprises two large surfaces extending substantially parallel and with a distance to each other and four lateral surfaces extending substantially at right angles to the large surfaces, wherein a first large surface has a lamination and wherein at least one recess is formed in the second large surface opposite the first large surface, said recess extending over the entire length or width of the second large surface, characterized in that the recess extends up to the lamination, without weakening the lamination, and that the recess has two surfaces converging toward each other under an angle α, wherein the angle α corresponds to the difference of 180° and the angle β between the building surfaces.

9. The insulating element according to claim 8, wherein the layer is made from mineral fibers bound with binding agents, particularly from rock and/or glass wool.

10. The insulating element according to claim 8, wherein at least one surface is provided with an adhesive, especially an adhesive which can be activated.

11. The insulating element according to claim 8, wherein the recess is made in the form of two incisions, which are oriented so as to converge toward each other under an angle α, wherein the incisions are not formed in a fashion crossing each other, so that between the incisions an element of insulating material is formed which can be removed, if necessary.

12. The insulating element according to claim 8, claim 1, wherein the recess is made in the form of several incisions, which are oriented so as to converge toward each other under different angles α, wherein the incisions are not formed in a fashion crossing each other, so that between the incisions elements of insulating material are formed which can be removed, if necessary.

13. The insulating element according to claim 8, wherein the recess subdivides the second large surface into differently wide surface sections preferably at a ratio of one third to two thirds of the width or length of the second large surface.

14. The insulating element according to claim 8, wherein the recess has a width which corresponds to twice the thickness of the layer of insulating material.

15. The insulating element according to claim 8, wherein the recess has a depth which substantially corresponds to thickness of the layer of insulating material.
